(19) United States
(12) Patent Application Publication
(10) Pub. No.: US 2026/0074492 A1
(43) Pub. Date: Mar. 12, 2026

(54) WIRE MANAGEMENT CLIP

(71) Applicant: Hubbell Incorporated, Shelton, CT (US)

(72) Inventor: Evan Martin, Litchfield, NH (US)

(21) Appl. No.: 19/320,075

(22) Filed: Sep. 5, 2025

Related U.S. Application Data
(60) Provisional application No. 63/691,456, filed on Sep. 6, 2024.

(51) Int. Cl. H02G 3/04; H02G 3/32; H02S 40/34

(52) U.S. Cl. CPC H02G 3/0437; H02G 3/32; H02S 40/34

(57) ABSTRACT

A wire management device that includes a connector, a first retainer, and a second retainer. The connector includes a first channel that can receive a support. The first retainer is connected to a first end of the connector. The first retainer includes a second channel that can receive a first electrical conductor. The second retainer is connected to a second end of the connector opposite to the first end. The second retainer includes a third channel that can receive a second electrical conductor. The first retainer extends from the first end in a different direction than the second retainer extends from the second end.

### CROSS-REFERENCE TO RELATED APPLICATIONS

This application claims the benefit of U.S. Provisional Application No. 63/691,456, filed Sep. 6, 2024, the entire contents of which is incorporated herein by reference in its entirety.

### FIELD

The present disclosure relates to a clip. More particularly, the present disclosure relates to an electrically isolated clip.

### BACKGROUND

Solar panel arrays have a large quantity of cables that can be managed under the array. For example, the cables should be properly supported and arranged along a structure. Proper management limits damage to the cables, which can limit fires or personal injury.

Many current solutions for managing cables involves using standard fasteners, like zip ties. These may be inexpensive to use, but may not be reusable, particularly when attempting to remove and/or reposition the cables.

Cable hangers may also be used to support the cables. However, hangers generally fail to secure the cables, which can permit shifting and eventually damage to the cables and/or the arrays.

Clips may be used in some examples to secure the cables in place. These clips are generally constructed from metal or another conductive material. The metal clip can conduct electrical current and create an unintended electrical pathway, which can cause damage to the arrays. Therefore, there is a need to properly support cables while limiting damage caused by the clip.

### SUMMARY

Various examples of the present disclosure can overcome various of the aforementioned and other disadvantages associated with known clips and offer new advantages as well.

According to one aspect of various examples of the present disclosure there is provided clip constructed from a first material and a second material that is non-conductive and different than the first material.

According to one aspect of various examples of the present disclosure there is provided clip constructed from a conductive material and a non-conductive material.

According to one aspect of various examples of the present disclosure there is provided clip constructed from a conductive material that is at least partially surrounded by a non-conductive material.

According to another aspect of various examples of the present disclosure, there is provided a wire management device that includes a connector, a first retainer, and a second retainer. The connector includes a first channel that can receive a support. The first retainer is connected to a first end of the connector. The first retainer includes a second channel that can receive a first electrical conductor. The second retainer is connected to a second end of the connector opposite to the first end. The second retainer includes a third channel that can receive a second electrical conductor. The first retainer extends from the first end in a different direction than the second retainer extends from the second end.

According to another aspect of various examples of the present disclosure, there is provided a wire management device that includes a connector and a first retainer. The connector includes a first channel with at least one prong. The prong is formed from a first material. The first retainer is connected to a first end of the connector. The first retainer includes a second channel. The first retainer is constructed from a second material. The first material may be conductive, and the second material may be insulative.

According to another aspect of various examples of the present disclosure, there is provided a wire management device that includes a connector, a first retainer, and a second retainer. The connector includes a first channel with at least one prong. The prong is formed from a first material. The first retainer is connected to the connector to form a second channel. The first retainer is constructed from a second material. The second retainer is connected to the connector to form a third channel. The second retainer is constructed from a third material. The first retainer extends along a first direction of the connector and the second retainer extends along a second direction of the connector. The first material can be conductive, the second material can be insulative, and the third material can be insulative.

The disclosure herein should become evident to a person of ordinary skill in the art given the following enabling description and drawings. The drawings are for illustration purposes only and are not drawn to scale unless otherwise indicated. The drawings are not intended to limit the scope of the disclosure. The following enabling disclosure is directed to one of ordinary skill in the art and presupposes that those aspects within the ability of the ordinarily skilled artisan are understood and appreciated.

### BRIEF DESCRIPTION OF THE DRAWINGS

Various aspects and advantageous features of the present disclosure will become more apparent to those of ordinary skill when described in the detailed description of preferred examples and reference to the accompany drawing wherein:

FIG. 1 is a perspective view of a clip.

FIG. 2 is a side view of the clip of FIG. 1.

FIG. 3 is a front view of the clip of FIG. 1.

FIG. 4 is a back view of the clip of FIG. 1.

FIG. 5 is a perspective view of the clip of FIG. 1, supporting electrical conductors.

FIG. 6 is a detail view of the clip of FIG. 5, with some of the electrical conductors removed.

FIG. 7 is a perspective view of the clip of FIG. 5 coupled to a support.

FIG. 8 is a front view of FIG. 7, with some of the electrical conductors removed.

### DETAILED DESCRIPTION

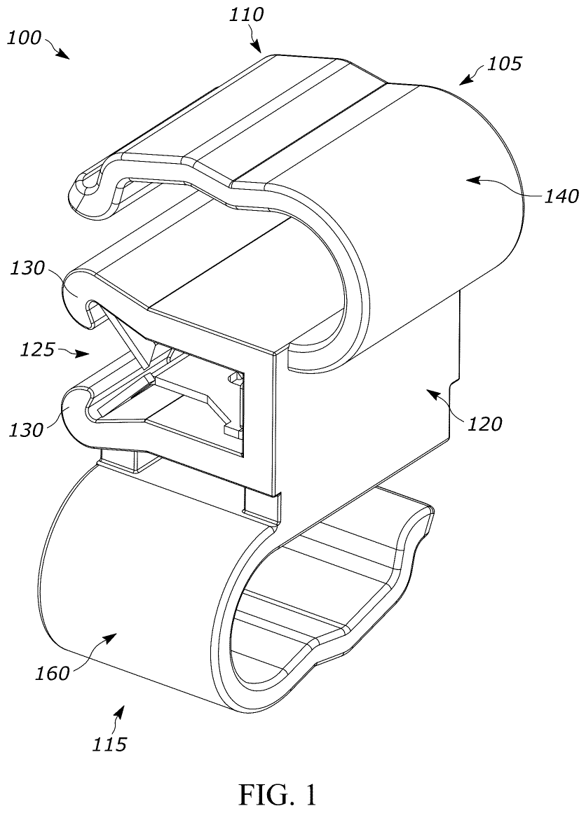

FIGS. 1 to 4 illustrate a wire management device or clip 100 that can be used to secure electrical conductors. The clip 100 includes a body 105 with an upper end 110 and a lower end 115. Upper and lower may refer to the orientation illustration in FIG. 1, although the clip 100 may be used in other orientations where the upper and lower ends 110, 115 are in a different orientation.

In some forms, the body 105 of the clip 100 may include a connector 120. In the illustrated example, the connector 120 may be at least partially open. For example, the connector 120 may have a substantially U-shape. However, other examples of the connector 120 may have a different shape.

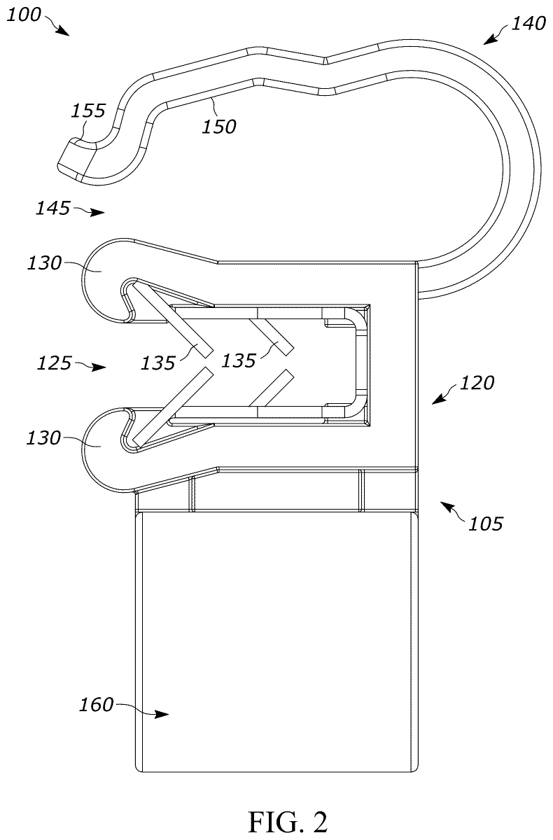

As shown in FIG. 2, the connector 120 may have an opening 125 that leads to a channel. The channel may be substantially rectangular in shape (e.g., as viewed in cross section), although other examples may include a different shape (e.g., a curved shape).

In some forms, the connector 120 may be wider proximate to the opening 125. For example, each free end of the connector may be angled away from the other free end so that the outer surface of the connector 120 is wider at the proximate to the opening 125.

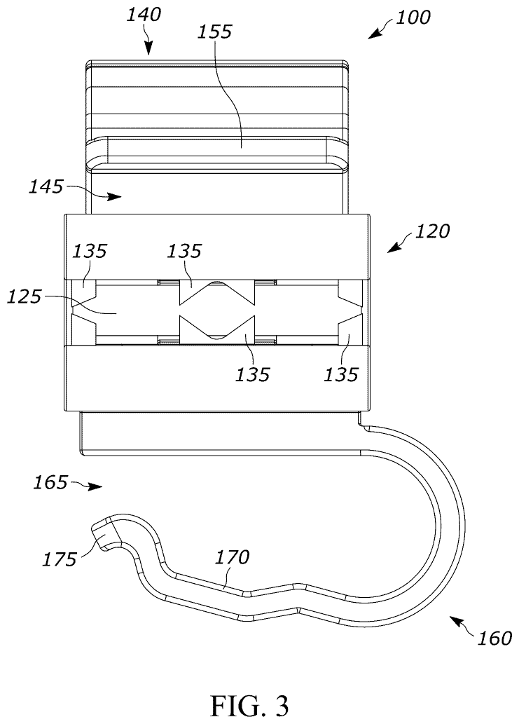

In some forms, one or more of the free ends (e.g., both shown) may include a hook or undercut portion 130. The undercut portion 130 on each free end may extend toward the center of the opening 125. Each undercut 130 may extend along substantially the entire length of the respective free end (see e.g., FIG. 3), although one or more of the undercuts 130 may extend along only part of the length of the free end.

With continued reference to FIG. 2, the connector 120 may include one or more prongs 135 disposed within the channel. The illustrated prongs 135 may be angled relative to the inner surface of the connector 120. For example, each prong 135 may be formed as a cantilever member with a fixed end on an inner surface of the channel and a free end that extends toward the center of the channel. The prongs 135 may be oriented so that the fixed ends are closer to the opening 125 than each respective free end.

As shown in FIG. 3, the illustrated connector 120 may include six prongs 135. Specifically, the connector 120 may include two center prongs 135 (e.g., one upper and one lower) and two pairs of outer prongs (e.g., an upper and lower outer prong positioned on either side of the center prongs 135). The free end of each of the prongs 135 may include an inclined shape. The direction of the incline may be toward the center of the channel. The illustrated center prongs 135 may be wider than the outer prongs 135, and the inclined shape may be a substantially V-shape. In other examples, the size, shape, and position may be different of one or more of the prongs 135, and/or there may be a different number of prongs 135.

In certain forms, the prongs 135 may be constructed from a different material than the rest of the connector 120. For example, the prongs 135 may be constructed from a metallic material and the remainder of the connector 120 may be constructed from an electrically insulated material (e.g., a plastic material). This may permit the prongs 135 to resiliently flex while the outer surface of the connector 120 is insulated. In other examples, the prongs 135 and the remainder of the connector 120 may be formed from any other material combination (e.g., entirely formed from plastic).

Returning to FIG. 2, the upper end 110 includes a first retainer 140. In the illustrated example, the first retainer 140 may have a curved shape, although other examples may include another shape (e.g., an angled shape).

In some forms, the first retainer 140 may be formed as a cantilever shape. For example, a fixed end of the first retainer 140 may be connected to a rear surface of the connector 120 (e.g., a surface opposite to the opening 125). A free end of the first retainer 140 may extend toward the free ends of the connector 120 so that the free end of the first retainer 140 is at least partially aligned with the free ends of the connector 120. An opening 145 may be formed between the free end of the first retainer 140 and the upper free end of the connector 120.

In some forms, a width between the inner surface of the first retainer 140 and the outer surface of the connector 120 may not be uniform along the length of the first retainer 140. For example, the width of the channel may generally decrease in the direction of the opening 145.

In certain forms, the decrease in width of the channel may be non-uniform along the length of the first retainer 140. In the illustrated example, a portion 150 of the first retainer 140 may extend outwardly (e.g., away from the surface of the connector 120). The width of the channel may be at least partially increased at this portion 150 (e.g., as compared to a first retainer 140) with a constant inner surface.

In some forms, the free end of the first retainer 140 may include a curved or hooked-shaped portion 155. In the illustrated example, the hooked-shaped portion 155 may be formed at a convex shape relative to the undercuts 130 of the connector 120. For example, the hooked-shaped portion 155 and the upper undercut 130 may curve away from one another.

In some forms, the first retainer 140 may be formed as a resilient member. For example, the first retainer 140 may be able to flex to adjust its position relative to the connector 120. The first retainer 140 may initially be in a neutral position and may be movable away from the connector 120 to increase the width of the opening 145 when an external force is applied. When the force is removed, the first retainer 140 may return to the neutral position.

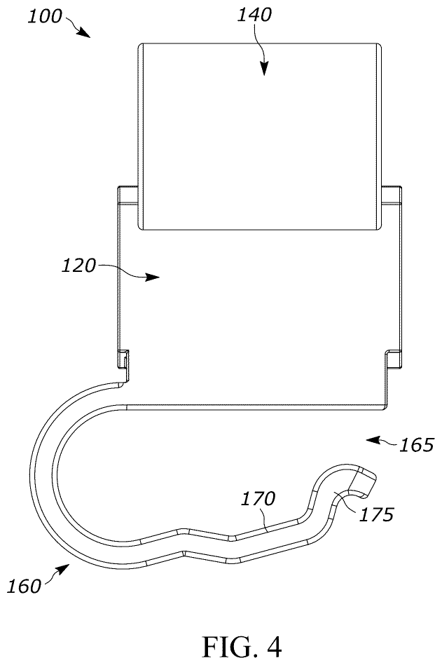

As shown in FIGS. 3 and 4, the lower end 115 includes a second retainer 160. The illustrated second retainer 160 may have substantially the same shape as the first retainer 140. Accordingly, only some similarities and differences are described below. Common elements include the same reference number, plus “20”.

In some forms, the second retainer 160 may be oriented at a different direction than the first retainer 140. For example, the second retainer 160 may be oriented about 90 degrees relative to the first retainer 140 so that the opening 165 of the second retainer 160 is oriented 90 degrees with respect to the opening 145 of the first retainer 140. The fixed end of the second retainer may be connected to a side of the connector 120 (e.g., as opposed to the back). The second retainer 160 may extend at least partially across the width of the connector 120. In this example, the second retainer 160 may be oriented so that the hook-shaped portion 175 is positioned proximate to the opposite side of the connector 120 than the fixed end, and the hook-shaped portion 175 and the fixed end may be substantially the same distance from the lower undercut 130.

In some forms, the second retainer 160 may be formed as a resilient member. For example, the second retainer 160 may be able to flex to adjust its position relative to the connector 120. The second retainer 160 may initially be in a neutral position and may be movable away from the connector 120 to increase the width of the opening 165 when an external force is applied. When the force is removed, the second retainer 160 may return to the neutral position.

In other examples (not shown), the second retainer 160 may be oriented at a different angle. For example, the second retainer 160 and the first retainer 140 may both be oriented in the same direction. Alternatively, the second retainer 160 may be oriented at an angle that is greater than or less than about 90 degrees (e.g., about 45 degrees, about 135 degrees, or about 180 degrees).

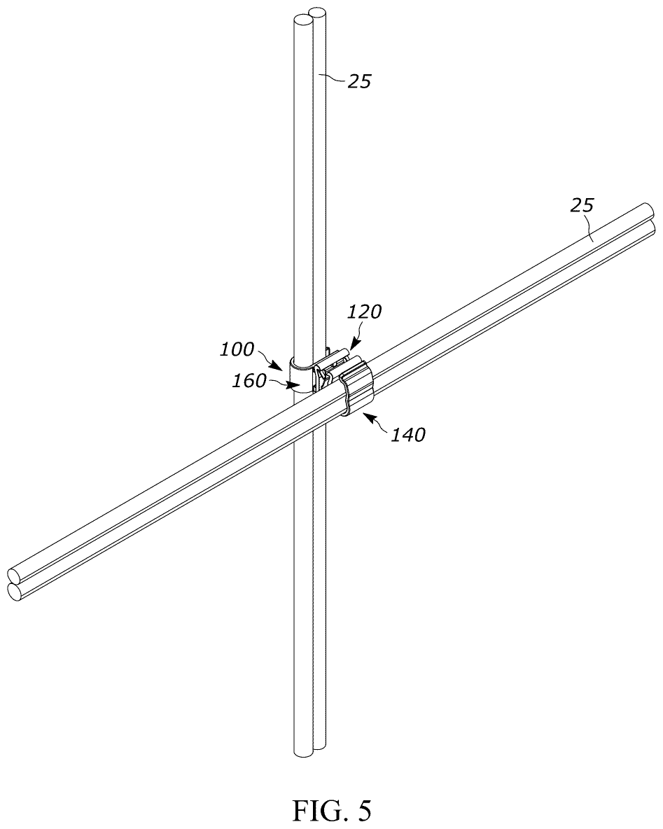

As shown in FIG. 5, the clip 100 may be used to at least partially retain electrical conductors 25. The electrical conductors 25 may be received within the first retainer 140 and or the second retainer 160. Because the first and second retainers 140, 160 are oriented in different directions, the clip 100 may be able to connect to electrical conductors 25 oriented in different directions.

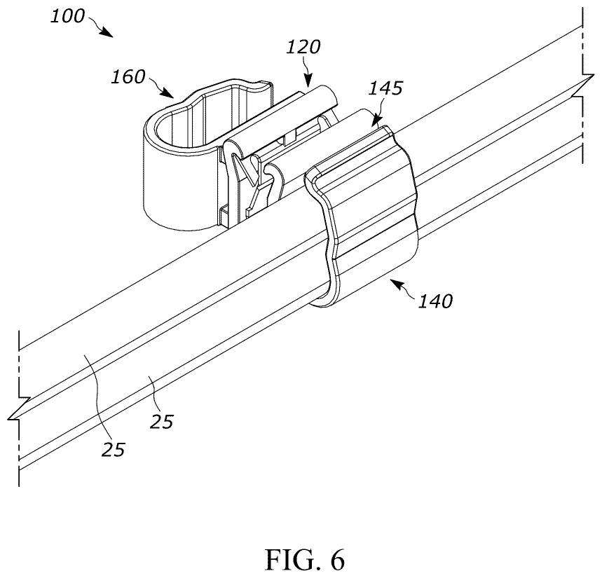

As shown in FIG. 6, two electrical conductors 25 may be inserted into each of the retainers 140, 160. The electrical conductors 25 may be oriented parallel to one another with one conductor 25 positioned proximate to the rear of the channel and the other conductor 25 positioned proximate to the opening 145, 165. In some forms, the portion 150, 170 may provide the additional width of the channel to retain both conductors 25. Residential adaptations may include a small number of electrical conductors 25, and thus each retainer 140, 160 may retain only a small number of conductors 25. However, some residential applications can include more electrical conductors 25 and/or the clip 100 could be used in a non-residential setting where there are more electrical conductors 25.

The first and second retainers 140, 160 may be biased toward the connector 120. When the electrical conductor 25 are inserted, the respective retainer 140, 160 may move away from the connector 120 to accommodate the insertion of the electrical conductor 25. Once the electrical conductor 25 is inserted, the respective retainer 140, 160 may return to its initial position. The retainer 140, 160 may assist in providing a clamping force to retain the electrical conductor 25 in position.

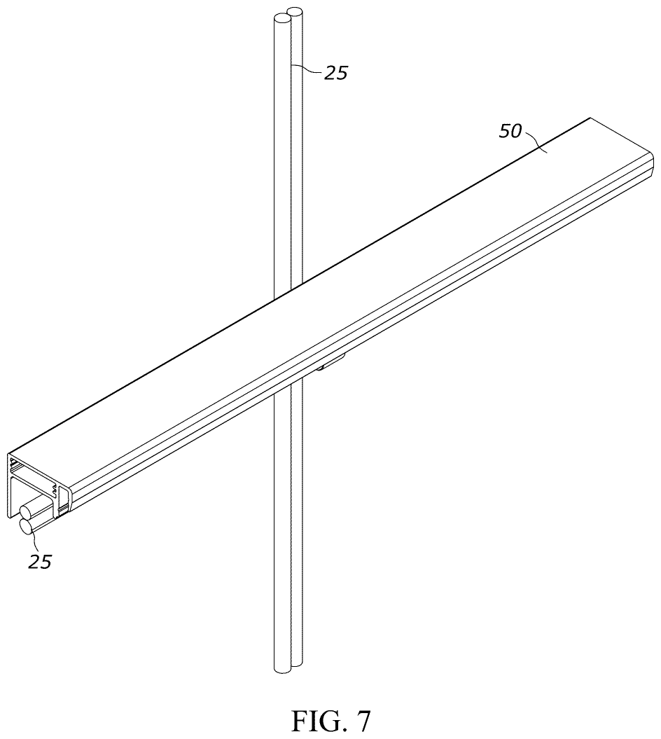

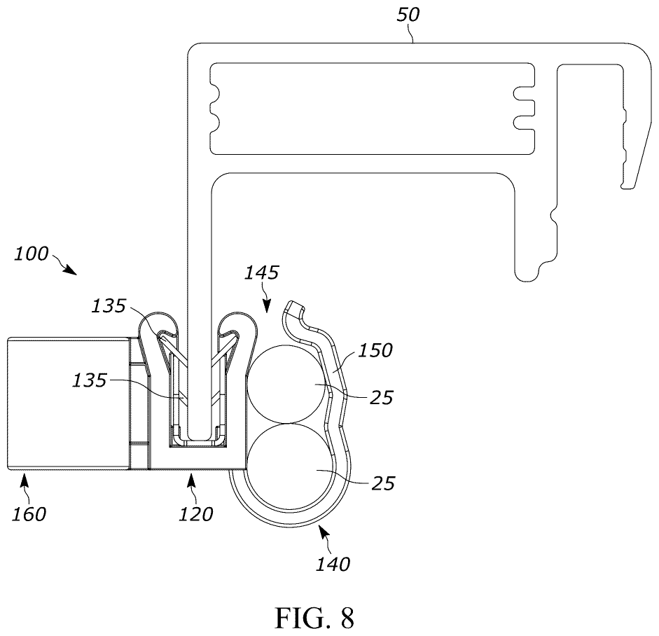

As shown in FIGS. 7 and 8, the clip 100 may be connected to a support 50. The support 50 may be any type of structure, but can particularly be a portion of a building (e.g., a residential building) that includes solar panels. However, the support 50 may be part of any structure (e.g., a non-residential structure) and/or may be entirely unrelated to solar panels.

As shown in FIG. 7, the illustrated support 50 is an elongated structure that may be constructed from a rigid material (e.g., metal). However, the support 50 may have other shapes and still permit connection with the clip 100.

As shown in FIG. 8, the connector 120 may engage the support 50. For example, channel of the connector 120 may receive at least a portion of the support 50. The illustrated support 50 may include an elongated section that may be approximately the same size as the channel.

In use, the opening 125 of each connector 120 may be positioned proximate to the support 50 and moved so that the opening 125 at least partially receives the support 50. As the support 50 moves into the channel, the prongs 135 may contact the support 50. The angle of the prongs 135 may permit the support 50 to enter the channel but may grip into the support 50 to limit the removal of the support 50 from the channel. For example, the connector 120 may be able to support the weight of the clip 100, as well as any electrical conductors 25, against the force of gravity. Although not illustrated, multiple clips 100 may be used along the length of the support 50 and may be connected to the same electrical conductors 25.

When coupled together, the prongs 135, which may be constructed from a metallic material, may remain in contact with the support 50. In many examples, the support 50 may be a conductive material, and thus electrical current could pass between the support 50 and the prongs 135. The remainder of the clip 100 (e.g., the first and second retainers 140, 160) may be constructed from the insulative material. Thus, any current passing between the prongs 135 and the support 50 may be unable to reach the first and second retainers 140, 160, and therefore the electrical conductors 25 supported by either retainer 140, 160. This may limit the creation of unintended electrical pathways, which could damage an electrical system (e.g., solar panel arrays).

The structure of the prongs 135 (e.g., a cantilever structure constructed from metal) may be able to grip the support 50 and retain the position of the clip 100 better than an alternative clip constructed entirely from an insulative material (e.g., plastic). Surrounding the prongs 135 with an insulative material may enable the gripping benefit without creating unwanted electrical pathways.

The first and second retainers 140, 160 may be oriented in different directions (e.g., 90 degrees apart) to receive electrical conductors 25 or other cables oriented in different directions. This may permit a single clip 100 to receive a variety of oriented electrical conductors 25, which may assist in reducing the total clips 100 used. The clips 100 can be manufactured with the first and second retainers 140, 160 at any orientation (including facing the same direction) to receive the differently oriented electrical conductors 25. Additionally, some examples may include a one or more retainers 140, 160 that are adjustable (e.g., pivotable relative to the connector 120) so that a technician can adjust the position of one or more retainers 140, 160 as needed for a specific use.

One of ordinary skill will appreciate that the exact dimensions and materials are not critical to the disclosure and all suitable variations should be deemed to be within the scope of the disclosure if deemed suitable for carrying out the objects of the disclosure.

One of ordinary skill in the art will also readily appreciate that it is well within the ability of the ordinarily skilled artisan to modify one or more of the constituent parts for carrying out the various examples of the disclosure. Once armed with the present specification, routine experimentation is all that is needed to determine adjustments and modifications that will carry out the present disclosure.

The above examples are for illustrative purposes and are not intended to limit the scope of the disclosure or the adaptation of the features described herein. Those skilled in the art will also appreciate that various adaptations and modifications of the above-described preferred examples can be configured without departing from the scope and spirit of the disclosure. Therefore, it is to be understood that, within the scope of the appended claims, the disclosure may be practiced other than as specifically described.

What is claimed is:

1. A wire management device comprising:
a connector including a first channel configured to receive a support;
a first retainer connected to a first end of the connector, wherein the first retainer includes a second channel configured to receive a first electrical conductor; and
a second retainer connected to a second end of the connector opposite to the first end, wherein the second retainer includes a third channel configured to receive a second electrical conductor;
wherein the first retainer extends from the first end in a different direction than the second retainer extends from the second end.

2. The wire management device of claim 1, wherein the second retainer is oriented 90 degrees relative to the first retainer.

3. The wire management device of claim 1, wherein the first retainer is movable between a first position where the second channel includes a first width and a second position where the second channel includes a second width that is greater than the first width.

4. The wire management device of claim 1, wherein the connector includes prongs that extend into the first channel, and wherein the prongs are configured to engage the support.

5. The wire management device of claim 1, wherein the connector is at least partially constructed from a first material and the first retainer is at least partially constructed from a second material that is different than the first material.

6. The wire management device of claim 5, wherein the first material is a conductive material and the second material is an insulative material.

7. The wire management device of claim 1, wherein the first retainer includes a curved portion and an outwardly extending portion within the second channel, and wherein the outwardly extending portion is spaced an equal distance apart from the connector as a maximum width of the curved portion.

8. A wire management device comprising:
a connector including a first channel having at least one prong, wherein the prong is formed from a first material; and
a first retainer connected to a first end of the connector, wherein the first retainer includes a second channel, and wherein the first retainer is constructed from a second material;
wherein first material is conductive and the second material is insulative.

9. The wire management device of claim 8, further comprising a second retainer connected to a second end of the connector opposite to the first end, wherein the second retainer includes a third channel configured to receive a second electrical conductor, and wherein the second retainer is constructed from a third material that is insulative.

10. The wire management device of claim 9, wherein the second material and the third material are the same.

11. The wire management device of claim 9, wherein the first retainer is fixed to a first edge of the connector and the second retainer is fixed to a second edge of the connector, wherein the first edge and the second edge are 90 degrees apart.

12. The wire management device of claim 9, wherein the first material is a metal, and wherein the second material and the third material are plastic.

13. The wire management device of claim 8, wherein the first retainer is formed as a cantilever member and a space between a free end and the connector forms an opening to the second channel, and wherein the opening to the second channel is oriented in the same direction as an opening to the first channel.

14. The wire management device of claim 8, wherein the at least one prong is formed as a cantilever member and is angled away from an opening to the first channel.

15. The wire management device of claim 8, wherein the first retainer includes a curved portion and an outwardly extending portion within the second channel, and wherein the outwardly extending portion is spaced an equal distance apart from the connector as a maximum width of the curved portion.

16. A wire management device comprising:
a connector including a first channel having at least one prong, wherein the prong is formed from a first material;
a first retainer connected to the connector to form a second channel, wherein the first retainer is constructed from a second material; and
a second retainer connected to the connector to form a third channel, wherein the second retainer is constructed from a third material;
wherein the first retainer extends along a first direction of the connector and the second retainer extends along a second direction of the connector; and
wherein first material is conductive, the second material is insulative, and the third material is insulative.

17. The wire management device of claim 16, wherein the second material and the third material are the same.

18. The wire management device of claim 16, wherein the first retainer includes a curved portion and an outwardly extending portion within the second channel, and wherein the outwardly extending portion is spaced an equal distance apart from the connector as a maximum width of the curved portion.

19. The wire management device of claim 16, wherein the at least one prong is formed as a cantilever member and is angled away from an opening to the first channel.

20. The wire management device of claim 16, wherein the first direction is perpendicular to the second direction.
